(19) United States
(12) Patent Application Publication
(10) Pub. No.: US 2010/0070507 A1
(43) Pub. Date: Mar. 18, 2010

(54) HYBRID CONTENT RECOMMENDING SERVER, SYSTEM, AND METHOD

(75) Inventor: Kouichirou Mori, Saitama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/404,508

(22) Filed: Mar. 16, 2009

(30) Foreign Application Priority Data
Sep. 12, 2008 (JP) 2008-235118

(51) Int. Cl. G06F 17/30; G06F 7/00

(52) U.S. Cl. 707/741; 707/E17.032; 707/E17.014

(57) ABSTRACT

A content recommending server includes: a content information collecting section collecting content information including metadata of contents from a content server through a network; a content database storing the content information collected by the content information collecting section; a user profile collecting section collecting user profiles of users from user terminals through the network, each of the user profiles including each user's preference; a user profile database storing the user profiles, the user profiles including a subject user profile; a content indexer acquiring the metadata and generating content indices of the contents; a user indexer acquiring the user profiles from the user profile database and generating user indices of each of the users; an index database storing the content indices and the user indices; and a content recommending section receiving the subject user profile, searching the index database for an certain index corresponding to the subject user profile, and determining a recommend content.

### CROSS-REFERENCE TO RELATED APPLICATIONS

This application is based upon and claims the benefit of priority from Japanese Patent Application No. 2008-235118, filed Sep. 12, 2008, the entire contents of which are incorporated herein by reference.

### BACKGROUND

1. Field

The present invention relates to a content recommending server, system, and method for recommending contents that are suitable for the tastes of a user.

2. Description of the Related Art

In recent years, with the advancement of digitization, access to many contents has become possible. For example, an enormous amount of digital content data such as book data, websites, news articles, blogs, TV programs, photographs, music, and moving images is accumulated on the Internet. And it is difficult for a user to find interesting contents manually from such an enormous amount of contents. To improve such a situation, content recommending systems which automatically recognize the tastes of a user and present contents that the user would prefer (refer to JP-A-2008-67370, for example) are needed. Using a content recommending system, a user can easily find his or her favorite contents from an enormous amount of contents.

The content recommending system is generally classified into a content-based system and a collaborative filtering system. The term “content-based recommending system” is a generic term of systems that employ techniques that are based on the details of contents. The fundamental approach of the content-based recommending system is to recommend contents similar to contents that a user prefers.

Judgment of similarity between contents requires information indicating the details of each content. For example, in the case of text contents such as websites, news articles, and blogs, similarity is judged by determining to what extent the contents have common words using the words included in the contents. Also in the case of books and TV programs, similarity can be determined by using words because they are associated with text metadata such as an author, a genre, persons who appear, and an outline. In the case of multimedia data such as photographs, music, and moving images, words can be used if they are associated with text metadata. If they are associated with no text metadata, similarity can be determined by using feature vectors such as color histograms (in the case of images) or waveforms or spectra (in the case of music).

The term “collaborative filtering recommending system” is a generic term of systems that employ techniques that utilize user profiles of other users. The “user profile” means a set of favorite content IDs. The basic approach of the collaborative filtering recommending system is to find other users who are similar in tastes to a user concerned and have the other users recommend contents that they prefer and the user concerned does not know. The collaborative filtering recommending system is advantageous in that a search for users who are similar in tastes does not require the details of each content, that is, it requires only content IDs for identification of contents. At present, commercial collaborative filtering recommending systems are used widely because of the advantage that it is not necessary to analyze the details of each content.

In summary, the content-based recommending system and the collaborative filtering recommending system are much different in approach in that the former searches for similar contents and the latter searches for similar users. Each of the content-based recommending system and the collaborative filtering recommending system performs basic processing of searching for similar contents or users.

In recent years, LSH (locality-sensitive hashing) is attracting attention as a technique or a data structure for searching for similar contents at high speed (refer to Non-patent documents: A. Z. Broder, “On the Resemblance and Containment of Documents,” Proceedings of the Compression and Complexity of Sequences, 1997; M. S. Charikar, “Similarity Estimation Techniques from Rounding Algorithms,” Proceedings of the 34th Annual ACM Symposium on Theory of Computing, 2002; and M. Datar, N. Immorlica, P. Indyk, and V. S. Mirrokni, “Locality-Sensitive Hashing Scheme on p-Stable Distributions,” Proceedings of the 20th Annual Symposium on Computational Geometry, 2004.). The LSH, which is a vicinity search algorithm, can find, at very high speed, contents similar to a content that is given as a query from a large-scale set of contents by placing, in advance, contents into a data structure called a hash (indexing).

The content-based recommending system and the collaborative filtering recommending system are different in what contents are recommended. Whereas the content-based recommending system has a disadvantage that the range of recommendation is narrow because only contents that excessively match the tastes of a user are recommended, the collaborative filtering recommending system is advantageous in that the range of recommendation is wide because the tastes of other users are reflected.

On the other hand, the collaborative filtering recommending system has a disadvantage that it cannot recommend niche contents that only a few users prefer or new contents just added because it requires user profiles, the content-based recommending system is advantageous in that it can recommend such contents.

As described above, there is a disadvantage that the content-based recommending system and the collaborative filtering recommending system have a tradeoff relationship and use of only one of them results in an insufficient form of recommendation.

A recommending system that is high in scalability (a scalable recommending system) means a system capable of operating at high speed even if its scale (the number of users and the number of contents) is large.

As mentioned above, the basic approach of the content-based recommending system is to search for similar contents and that of the collaborative filtering recommending system is to search for similar users. Therefore, conventional content-based recommending systems have a disadvantage that the scalability lowers as the number of contents increases and conventional collaborative filtering recommending systems have a disadvantage that the scalability lowers as the number of users increases.

### SUMMARY OF THE INVENTION

According to an aspect of the present invention, there is provided a content recommending server including: a content information collecting section collecting content information including metadata of contents from a content server through a network; a content database storing the content information collected by the content information collecting section; a user profile collecting section collecting user profiles of users from user terminals through the network, each of the user profiles including each user's preference with respect to the contents; a user profile database storing the user profiles collected by the user profile collecting section, the user profiles including a subject user profile of a subject user; a content indexer acquiring the metadata from the content database and generating content indices of the contents from the metadata; a user indexer acquiring the user profiles from the user profile database and generating user indices of each of the users by using the preference as a key; an index database storing the content indices and the user indices; and a content recommending section receiving the subject user profile from the user profile database, searching the index database for an certain index corresponding to the subject user profile, and determining a recommend content suitable for a preference of the subject user based on the certain index.

According to an another aspect of the present invention, there is provided a content recommending method including: collecting content information including metadata of contents from a content server through a network; collecting user profiles of users from user terminals through the network, each of the user profiles including each user's preference with respect to the contents; generating content indices of the contents from the metadata; generating user indices of each of the users by using the preference as a key; acquiring a subjected user profile of a subject user from the collected user profiles; searching content indices and user indices for an certain index corresponding to the subject user profile, and determining a recommend content suitable for a preference of the subject user based on the certain index.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the entire configuration of a content recommending system according to an embodiment.

FIG. 2 shows a relationship between modules of a content recommending server.

FIG. 3 is a flowchart showing a specific example of a process which is executed by an indexing section.

FIG. 4 is a flowchart showing a specific example of a process which is executed by a content recommending section.

FIG. 5 shows a specific example of the indexing process.

FIG. 6 shows a specific example of the content recommending process.

FIG. 7 is a block diagram showing the entire configuration of a program recommending system.

FIG. 8 shows specific examples of program metadata.

FIG. 9 is a flowchart of a specific process executed by a content indexer in a case that contents are represented by text metadata.

FIG. 10 shows examples of an index words/documents matrix, random number sequences, and a signature matrix.

FIG. 11 is a specific example of processing of indexing programs into an LSH.

FIG. 12 shows specific examples of user profiles.

FIG. 13 is a flowchart of a specific process executed by a user indexer.

FIG. 14 shows an example of processing of indexing user information into an LSH.

FIG. 15 is a flowchart of a specific example of process executed by the user indexer to generate preference vectorpreference vectors.

FIG. 16 shows specific examples of user indexing using preference vectorpreference vectors.

FIG. 17 is a schematic chart showing how a large-scale set of contents or pieces of user information is indexed.

FIG. 18 shows a specific example of a recommendation list which is presented to a user.

### DETAILED DESCRIPTION

An embodiment of the present invention will be hereinafter described with reference to the drawings. First, the entire configuration of a system, a module configuration, and processes will be described without restricting the kind of contents. Then, a specific description will be made of a TV program recommending system in which contents are restricted to TV programs that are represented by text metadata.

### <Entire Configuration of System>

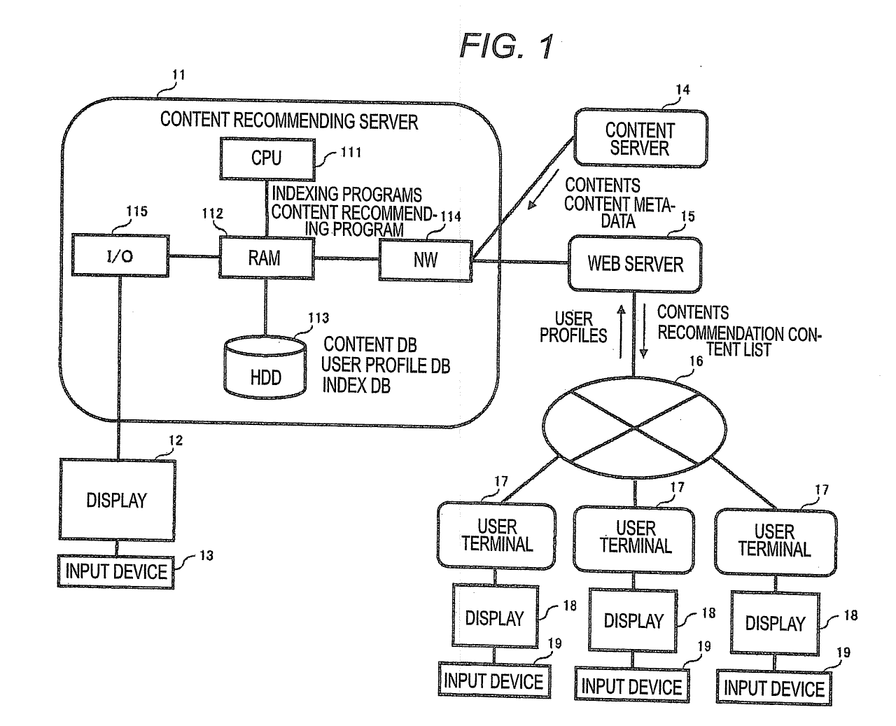

FIG. 1 is a block diagram showing the entire configuration of a content recommending system according to the embodiment of the invention.

A content recommending server 11 is composed of a CPU 111 which runs programs, a RAM 112 to be loaded with indexing programs and a content recommending program, a hard disk drive 113 for storing a content DB (database), a user profile DB, and an index database, a network device 114 for exchanging information with other servers, and an input/output device 115 for performing input/output of information between the content recommending server 11 and an input device 13. A display 12 and the input device 13 are a display device and an input device, respectively, that are necessary when, for example, a manager of the content recommending server 11 inputs contents or updates existing contents.

A content server 14 is another server which manages pieces of content information. For example, where contents are TV programs, the content server 14 corresponds to broadcasting stations and pieces of content information are transmitted from the content server 14. Where contents are data of books, images, music, moving images, or the like, they can be acquired by using Web APIs provided by content servers of other companies.

A web server 15 is a server which provides an interface between the content recommending server 11 and users. For example, the content recommending server 11 displays contents and each user selects, views, purchase, or rates the displayed contents. History information relating to such activities of each user is sent to the content recommending server 11 via the Web server 15 and stored in the hard disk drive 113 as a user profile.

A network 16 is a wide area network such as the Internet which connects the content recommending server 11 and user terminals 17. The user terminals 17 are apparatus that allow the users to access the Web server 15 and it is assumed that they can access the network 16. Examples of each user terminal 17 are a personal computer, a PDA, a cell phone, a TV receiver, and a hard disk recorder. It is assumed that each user terminal 17 is equipped with a display 18 and an input device 19. Each user can view contents and read a recommendation content list (transmitted from the content recommending server 11) through the display 18. Each user can manipulate contents through the input device 19; for example, each user can select, view, purchase, and rates contents.

### <Module Configuration of Content Recommending Server 11>

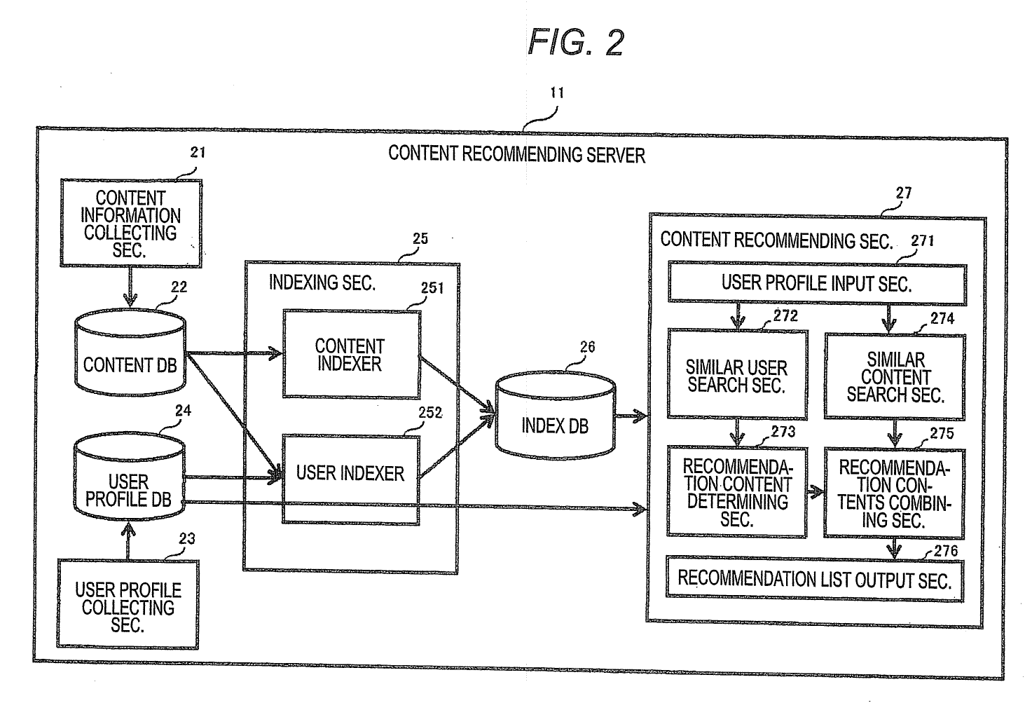

FIG. 2 shows a relationship between modules of the content recommending server 11.

A content information collecting section 21 is a module for collecting pieces of content information such as content bodies and metadata of contents from the content server 14. A content DB 22 is a database for storing the pieces of content information collected by the content information collecting section 21. Only metadata of contents may be stored in the content DB 22 (i.e., content bodies are not stored). Where only metadata of contents are stored, it is necessary to provide the user terminals 17 with links to the contents. And the user terminals 17 need to acquire those contents from the content server 14.

A user profile collecting section 23 is a module for collecting, in the form of user profiles, pieces of manipulation history information of manipulations performed by the users on contents through the user terminals 17. A user profile DB 24 is a database for storing the user profiles collected by the user profile collecting section 23. The user profile collecting section 23 collects information indicating what contents each user has selected, viewed, purchased, and rated, and stores it in the user profile DB 24. In this embodiment, information (taste information) indicating what contents each user is interested in is called a user profile. The embodiment assumes a state that user profiles have been collected over a certain period and are stored in the user profile DB 24.

An indexing section 25 is a module for converting contents or pieces of user information into feature vectors and placing them into a data structure called LSH (locality-sensitive hash) The indexing section 25 is composed of a content indexer 251 for indexing contents and a user indexer 252 for indexing pieces of user information. In the embodiment, processing of converting original data such as a content or user information into certain data and placing it into a certain data structure is called indexing. The data thus generated is called an index. Data is compressed by indexing, which provides such advantages as reduction in storage area and increase in search speed.

An index DB 26 is a database for storing indices generated by the indexing section 25. Indices are expressed as a data structure called LSH. In the embodiment, indices of contents and indices of pieces of user information are placed into the same LSH in the index DB 26.

A content recommending section 27 is a module group for recommending contents to a user (hereinafter referred to as a “recommendation request user”) whose requests recommendation of contents. The content recommending section 27 is composed of a user profile input section 271, a similar user search section 272, a recommendation content determining section 273, a similar content search section 274, a recommendation contents combining section 275, and a recommendation list output section 276.

For example, when an ID for a recommendation request user is input, a user profile of the recommendation request user is acquired from the user profile database 24.

When the user profile of the recommendation request user is input to the user profile input section 271, the similar user search section 272 searches the index DB 26 for users who are similar in tastes to the recommendation request user. At the same time, the similar content search section 274 searches index DB 26 for contents that are similar to contents that the recommendation request user prefers. In this manner, the use of the index DB 26 makes it possible to search for similar users and similar contents simultaneously at high speed.

The recommendation content determining section 273 is a module for selecting, using a technique called collaborative filtering, contents on the basis of the similar users found by the similar user search section 272. In doing so, the recommendation content determining section 273 needs to access the user profile DB 24 because it uses the user profiles of the similar users.

The recommendation contents combining section 275 is a module for combining the recommendation contents of the similar content search section 274 with those of the recommendation content determining section 273. A recommendation list output section 276 is a module for outputting recommendation contents for the recommendation request user in the form of a recommendation list. The recommendation list is transmitted to the user terminal of the recommendation request user via the Web server 15.

### <Processes Executed by Content Recommending Server 11>

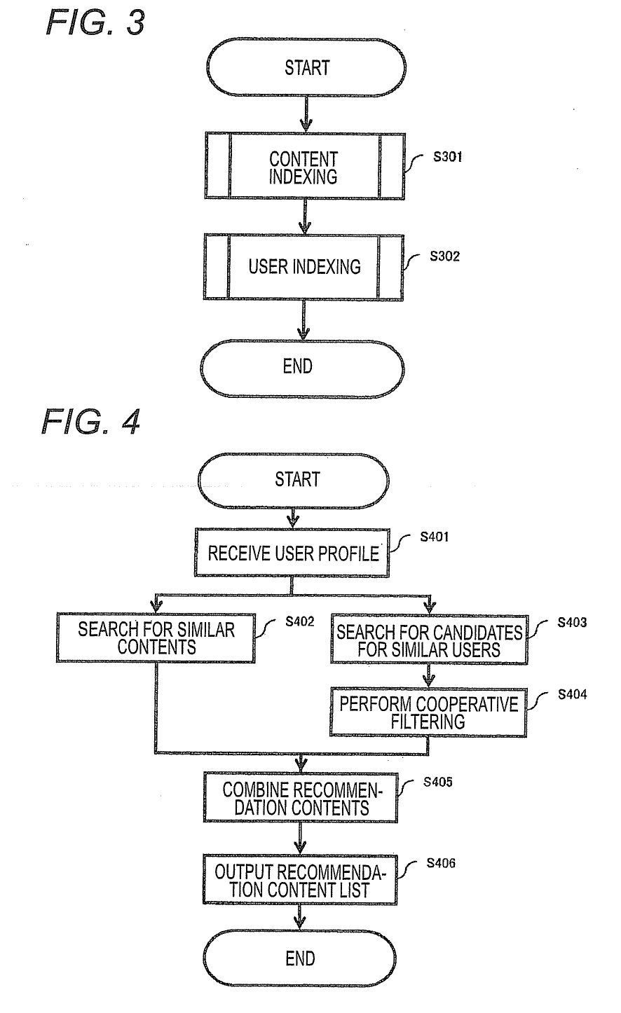

FIG. 3 is a flowchart showing a specific example of a process which is executed by the indexing section 25. At step S301, the content indexer 251 indexes all the contents in the content DB 22 and stores resulting indices in the index DB 26. At step S302, the user indexer 252 indexes all the pieces of user information in the user profile DB 24 and stores resulting indices in the index DB 26.

Steps S301 and S302 can be executed parallel because they are independent of each other. The details of each of steps S301 and S302 depend on the kind of contents to be processed. Steps S301 and S302 will be described later in detail for a case that contents to be processed are text metadata of TV programs.

FIG. 4 is a flowchart showing a specific example of a process which is executed by the content recommending section 27.

At step S401, a user profile of a recommendation request user is input. At step S402, contents that are similar to the contents in the user profile that the recommendation request user prefers are searched for. At step S403, users who are similar in tastes to the recommendation request user are searched for on the basis of the user profile of the recommendation request user.

At step S404, recommendation contents for the recommendation request user are calculated from the set of users who are similar in tastes to the recommendation request user by the technique called collaborative filtering. At step S405, the recommendation contents determined by steps S402 and S404 are combined together.

At step S406, a list of recommendation contents is output. In the above process, step S402 performs content-based recommendation and steps S403 and S404 perform collaborative filtering type recommendation. Step S405 combines results of the two kinds of recommendation, whereby hybrid recommendation is realized which secures the advantages of the two kinds of recommendation.

### <Example Processes>

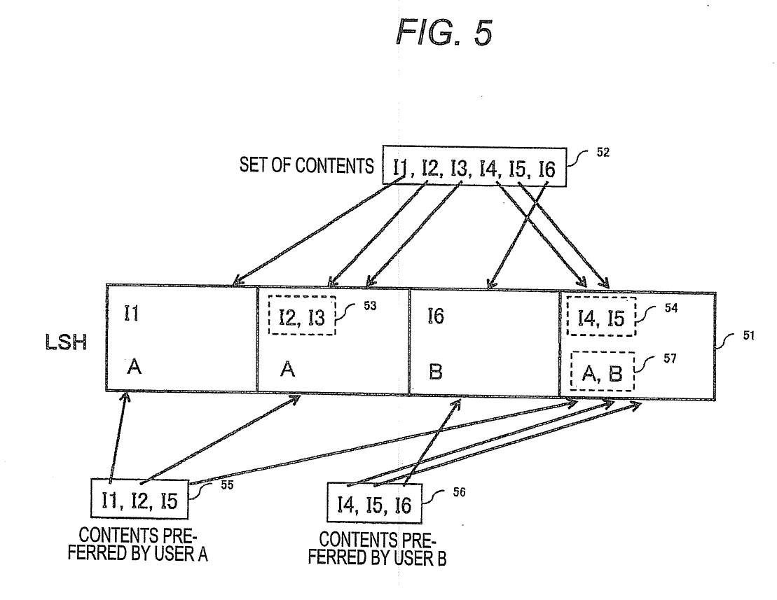

FIG. 5 shows a specific example of the indexing process of FIG. 3. The indexing DB 26 uses a data structure called LSH. The LSH is a data structure that is very similar to a hash. In a general hash, the same contents are placed into the same bin (corresponds to each box of the LSH 51; there are four bins in this example). The LSH has a feature that contents that are higher in similarity are more likely placed into the same bin.

In the embodiment, contents and pieces of user information are indexed in advance and placed into an LSH. First, at step S301, all the contents in the content DB 22 are indexed and placed into an LSH by the content indexer 251. In this example, there are six contents I1, I2, I3, I4, I5, and I6 which are identified by content IDs. Each content is converted into a vector expression called a feature vector. The contents as expressed as feature vectors are placed into an LSH by a technique described later. The method for placing contents into an LSH depends on the kind of contents and hence will be described later in detail. Indexing results of the contents I1-I6 are shown in the upper part of the LSH 51. Data that are located in the same bin of the LSH 51, such as data 53 and 54, are regarded as data of similar contents. For example, the contents I2 and I3 are similar and the contents I4 and I5 are similar.

At step S302, all the pieces of user information in the user profile DB 24 are indexed by the user indexer 252. In this example, user profiles of two users are indexed. There are two methods for expressing each user profile, that is, a method of expressing each user profile in the form of a set of contents that the user prefers and a method of expressing each user profile in the form of feature vectors of a set of contents that the user prefers in the same manner as contents are done. The embodiment employs the former method. Whether the user prefers a content may be judged on the basis of whether the user selected, viewed, or purchased it, or rated it high. Each piece of user information is indexed by placing all the contents in the user profile into the LSH 51 in the same manner as contents not in a user profile are done. In the above process, user IDs (in this example, A and B), rather than content IDs (in this example, I1, I2, etc.), is placed into the LSH 51. Results of indexing of the pieces of user information are shown in the lower part of the LSH 51. Users corresponding to user IDs placed in the same bin of the LSH 51, such as (A, B) (denoted by symbol 57), are users who have the same tastes for a certain content. For example, both of the users A and B prefer the content I5.

The LSH 51 generated according to the above process is stored in the index DB 26. Contents and user IDs are placed into the same LSH. Since a user profile is expressed as a set of contents, it can be placed into the same LSH as contents.

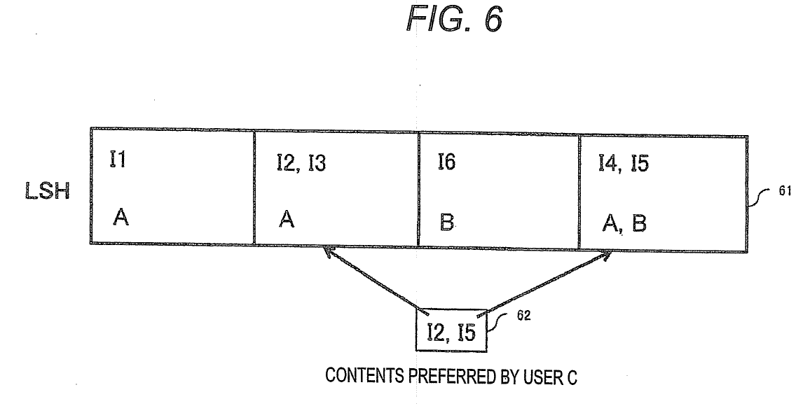

FIG. 6 shows a specific example of the content recommending process of FIG. 4. A description will be made of a case of recommending contents to a recommendation request user C using the LSH 51 generated as shown in FIG. 5.

First, at step S401, a user profile of the recommendation request user C is input. In this example, a user profile 62 of the recommendation request user C is (I2, I5). That is, the user C prefers the contents I2 and I5.

At step S402, all the contents in the user profile are hashed and content IDs located in hashing destinations are taken out. In this example, contents (I2, I3) located in a hashing destination of the content I2 and contents (I4, I5) located in a hashing destination of the content I5 are taken out. Contents (I3, I4) are obtained by removing the contents I2 and I5 that the recommendation request user C already knows. As described above (i.e., the property of the LSH), in the LSH, contents that are higher in similarity are more likely placed into the same bin. It is therefore seen that the contents I3 and I4 that are similar to the respective contents I2 and I5 that the user C prefers have been obtained. The contents I3 and I4 are recommended because it is highly probable that the user C prefers them. Since this processing is based on similarities between the contents, it can be regarded as content-based recommendation.

Likewise, at step S403, user IDs located in the hashing destinations are taken out. In this example, a user ID A located in the hashing destination of the content I2 and user IDs (A, B) located in the hashing destination of the content I5 are taken out. User IDs (A, B) are obtained by avoiding duplication. The users A and B are users who share favorite contents with the recommendation request user C. That is, the users A and B are considered candidates for users who are similar in tastes to the recommendation request user C.

At step S404, collaborative filtering is performed by using the candidates for users who are similar in tastes to the recommendation request user C. The collaborative filtering is a generic term of techniques for obtaining recommendation contents from a user who is similar in tastes to a recommendation request user, and various methods are currently available. In this example, the simplest method is employed in which contents that the recommendation request user does not know among contents that users who are similar in tastes to the recommendation request user prefer are recommended. It is recognized from the user profile DB 24 that the user A prefers contents (I1, I2, I5) and the user B prefers contents (I4, I5, and I6). Removing the contents I2 and I5 that the user C prefers, contents (I1, I4, and I6) are obtained and recommended. Since this processing is based on the users who are similar in tastes to the recommendation request user C, it can be regarded as collaborative filtering type recommendation.

According to the above description, all the contents in the user profile of the recommendation request user C are hashed and content IDs and user IDs in hashing destinations are obtained at the same time. That is, both of contents that are similar to the contents that the recommendation request user C prefers and users who are similar in tastes to the recommendation request user C can be obtained at the same time, that is, content-based recommendation and collaborative filtering type recommendation can be performed simultaneously. Furthermore, since the LSH is used, similar contents and similar users can be found at high speed and the recommendation is scalable with respect to increase in either of the number of contents and the number of users.

Finally, at step S405, the contents (I3, and I4) obtained by the content-based recommendation and the contents (I1, I4, and I6) obtained by the collaborative filtering type recommendation are combined together. The combining can be done by several methods. For example, contents (I1, I3, I4, and I6) are obtained by ORing the two sets of contents or I4 is obtained by ANDing the two sets of contents. The weighting between the content-based recommendation and the collaborative filtering type recommendation can be adjusted. For example, a procedure is possible in which great importance is attached to the content-based recommendation at the initial stage of operation of the recommendation system because the histories of other users do not contain much information yet and the collaborative filtering type recommendation is regarded as more important as the histories of the other users come to contain a sufficient amount of information. The recommendation contents obtained by the combining are output as a recommendation list at step S406, and presented to the recommendation request user C via the Web server 15.

### <Program Recommending System>

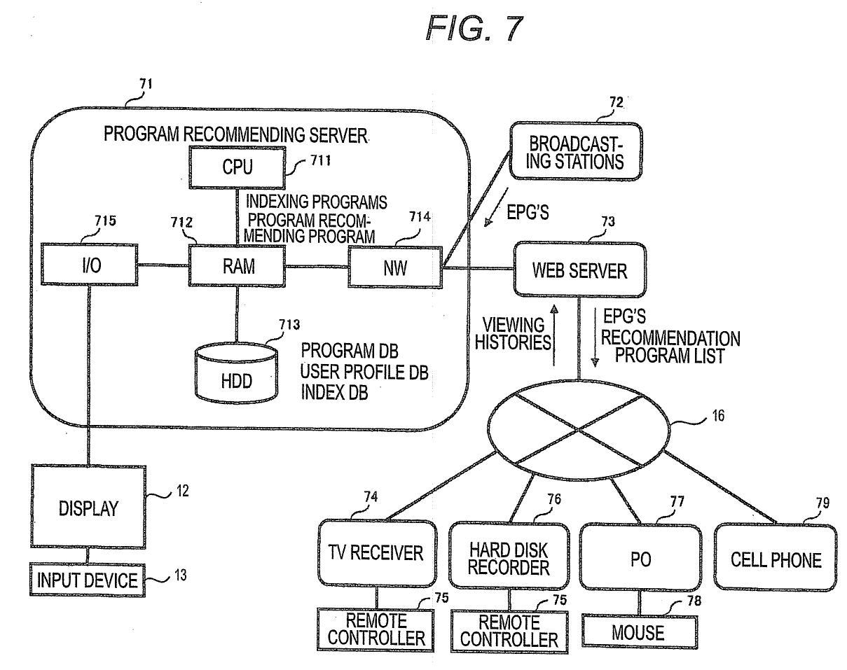

In the following, processes which are executed by a specific system will be described by assuming a case that contents are TV programs. FIG. 7 is a block diagram showing the entire configuration of a program recommending system. Whereas FIG. 7 is the same as FIG. 1 (block diagram) in most parts, there are several differences because of handling of TV programs. The content recommending server 11 is replaced by a program recommending server 71, the content server 14 is replaced by a broadcasting stations 72, and the user terminals 17 are replaced by apparatus that enable viewing of TV programs such as a TV receiver 74, a hard disk recorder 76, a personal computer 77, and a cell phone 79.

The program recommending server 71 stores, in advance, electronic program guides (EPGs) which are program metadata by downloading them from the broadcasting stations 72 on a regular basis. In the case of the digital broadcast, an EPG is delivered together with program contents by radio.

The program recommending server 71 is required to hold only EPGs which are program metadata. Data of TV program bodies (video etc.) are distributed to the user terminals from the broadcasting stations 72. What the program recommending server 71 provides as a recommendation list is program metadata.

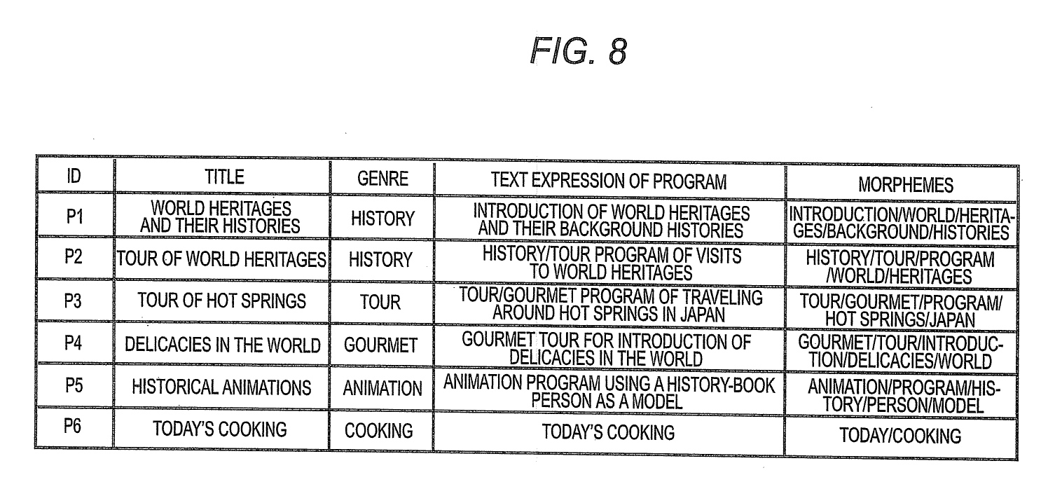

FIG. 8 shows specific examples of program metadata. Program metadata, which corresponds to each program, is data including a broadcast date, a broadcast start time, a broadcasting station, a genre, a title, persons who appear, and details of the program. In the examples of FIG. 8, each metadata includes a title, a genre, and a text expression of the program (morphemes will be described later). Each program is given a unique program ID and is thereby discriminated from other programs. In the description made so far, the process executed by each module was described in such a manner that contents regarded as an abstract ones (i.e., the kind of contents was not restricted). However, the procedure of the indexing depends on the properties of subject contents.

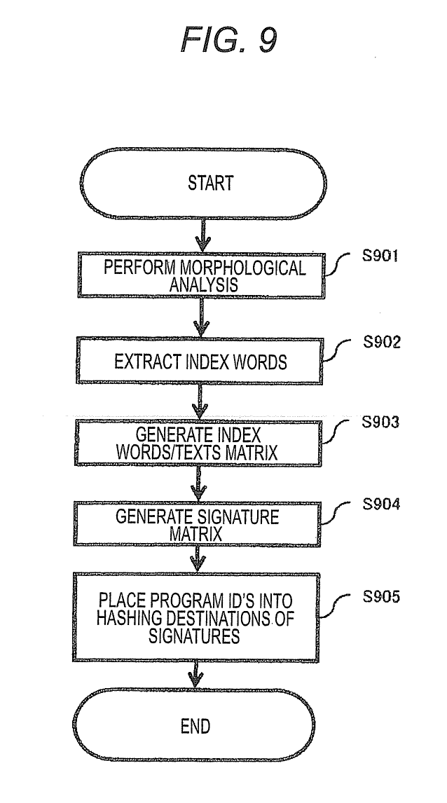

The detailed procedure of the indexing will be described below for a case that contents are represented by text metadata as shown in FIG. 8. FIG. 9 is a detailed flowchart of content indexing (step S301) in a case that contents are represented by texts such as program metadata.

At step S901, a morphological analysis is performed which decomposes the text expression of each program into a set of words. In the example of FIG. 8, the text expression of each program is decomposed into words by a morphological analysis and only nouns are extracted to generate an array of morphemes. Morphemes are employed as components of a feature vector representing the details of each program. And morphemes are thus used for judging similarity between programs. For example, two programs are judged higher in similarity when they have more common words. Although in this example only a text expression of each program is subjected to a morphological analysis, the other pieces of information of each program metadata such as the title, genre, and persons who appear may also be subjected to a morphological analysis.

At step S902, index words are selected from the morphemes extracted from the text expression of each program. The index words are words that characterize the details of a program properly, and are selected from morphemes. A TF-IDF method, for example, is commonly known as a method for selecting index words from morphemes. However, in many cases the TF-IDF method does not work properly in the case where the subject is a relatively short text like a text expression of a program. Therefore, in the embodiment, all morphemes are selected as index words.

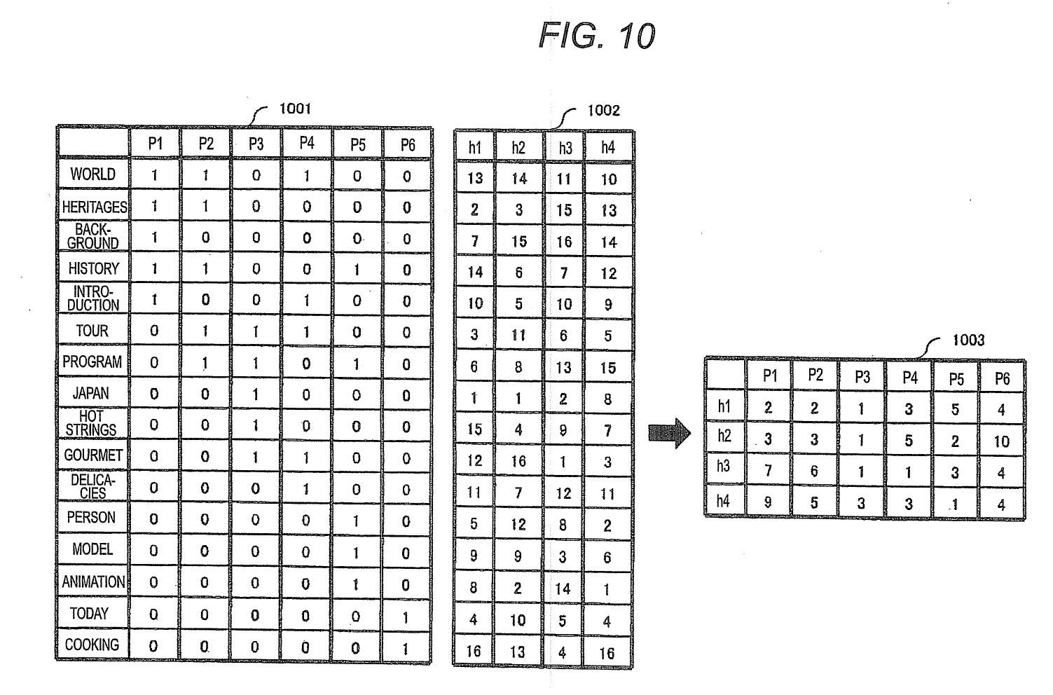

At step S903, an index words/documents matrix is generated. In this example, the programs are texts. FIG. 10 shows specific examples of an index words/documents matrix, random number sequences, and a signature matrix. In FIG. 10, a matrix 1001 is an example index words/documents matrix which is generated from the program metadata of FIG. 8. The index words/documents matrix is a matrix in which the rows correspond to respective index words and the columns correspond to respective programs. A matrix element is given a value “1” if the program includes the index word and is given a value “0” is the program does not include the index word. For example, the column P1 of the matrix 1001 means that the program P1 includes the index words “world,” “heritages,” “background,” and “histories,” “introduction.” The index words/documents matrix 1001 shows feature vectors of respective programs. For example, the feature vector of the program P1 is a 16-dimensional vector (1, 1, 1, 1, 1, 0, 0, . . . , 0) which corresponds to the column P1. The number of dimensions (length) of the feature vector of each program is equal to the number of all index words. Although in this example values “0” and “1” are used which indicate whether the index word is included, scores of the above-mentioned TF-IDF method may be used.

At step S904, a signature matrix 1003 is generated from the index words/documents matrix 1001. The signature matrix is a summary expression obtained by reducing the number of dimensions of the feature vectors of programs, and each signature is expressed as a vector like the program is. Whereas the feature vector of each program of the original index words/documents matrix 1001 is a 16-dimensional vector, in the signature matrix 1003 the signature of each program is compressed to a 4-dimensional vector. Various methods for converting a feature vector into a signature by reducing the number of dimensions. In the embodiment, a technique called min-hashing is employed (refer to A. Z. Broder, “On the Resemblance and Containment of Documents,” Proceedings of the Compression and Complexity of Sequences, 1997). The min-hashing is a dimension reducing method that is suitable for a sparse matrix (most of the elements are 0) such as an index words/documents matrix. To reduce the number of dimensions by the min-hashing, plural random number sequences 1002 are necessary. Each random number sequence is a series in which numbers from “1” to the number of index words are arranged randomly. This example employs four random number sequences h1 to h4.

The min-hashing determines a signature by applying the random number sequences to the feature vector of each program. For example, the random number sequence hi is applied to the program P1 in the following manner. First, random numbers corresponding to the components having the value “1” of the vector P1 are extracted from the random number sequence h1 to produce a sequence “13, 2, 7, 14, 10.”

Then, the minimum number (in this example, “2”) is selected from these numbers and is written at the intersection of the vector P1 and the random number sequence h1 in the signature matrix 1003.

For another example, the random number sequence h2 is applied to the program P2 in the following manner. First, random numbers corresponding to the components having the value “1” of the vector P2 are extracted from the random number sequence h2 to produce a sequence “14, 3, 6, 11, and 8.” Then, the minimum number (in this example, “3”) is selected from these numbers and is written at the intersection of the vector P2 and the random number sequence h2 in the signature matrix 1003.

The signature matrix 1003 is obtained by performing the above processing on all combinations of a program and a random number sequence.

Although in this example the numbers of dimensions (the number of index words) of each feature vector and each signature are as small as 16 and 4, respectively, in an actual case of dealing with a large number of programs the number of dimensions of each feature vector may be as large as tens to hundreds of thousands. It is known that even in such a case signatures of about 100 dimensions work well. That is, an appropriate procedure is to perform min-hashing by preparing 100 random number sequences h1 to h100.

In practice, very long random number sequences may become necessary as the number of dimensions of each feature vector increases. In such a case, a minimum perfect hash function may be used. Furthermore, an algorithm is known which can determined a signature matrix at high speed even in the case where the number of dimensions of each feature vector is large.

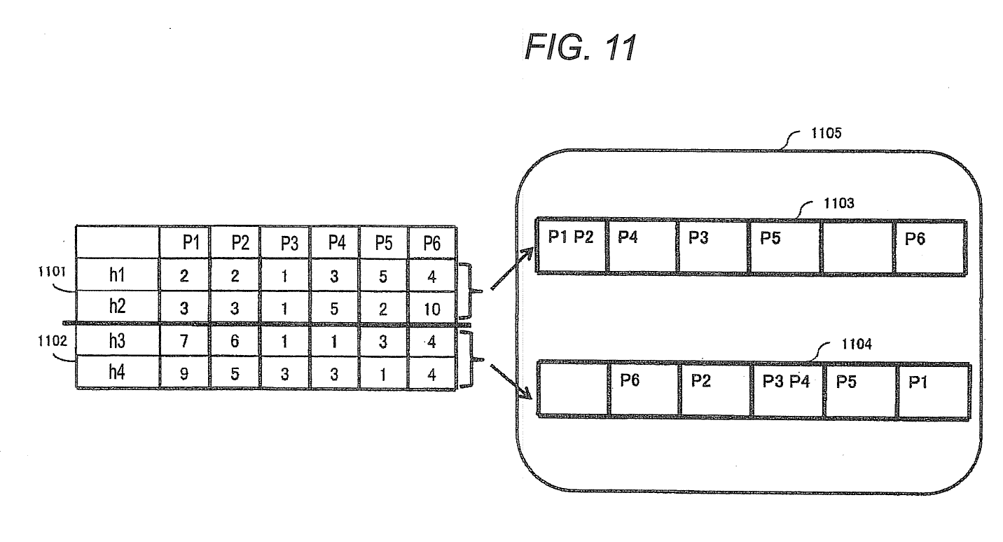

At step S905, the programs are indexed into an LSH. FIG. 11 shows a specific example of processing of indexing the programs into an LSH. First, the signature matrix 1003 is divided into several bands. In this example, the signature matrix 1003 is divided into two bands 1101 and 1102. Then, hashes are prepared for the respective bands 1101 and 1102 and the program IDs are placed into the hashes using the divisional signatures as keys. In this example, a hash 1103 corresponds to the band 1101 and a hash 1104 corresponds to the band 1102. Since the programs P1 and P2 of the band 1101 have the same signature (2, 3), they are placed into the same bin of the hash 1103. In the hashing, subjects are placed into the same bin if their keys are the same. Likewise, the programs P3 and P4 of the band 1102 are placed in the same bin of the hash 1104 because they have the same signature (1, 3). Programs that are hashed into the same bin are programs which are similar at a high probability. For example, the program P1 (“World Heritages and their histories”) and the program P2 (“Tour of World Heritages”) both relate to the World Heritages and hence are similar in content. The program P3 (“Tour of hot springs”) and the program P4 (“Delicacies in the world”) are both classified as a tour/gourmet program and hence are similar in content. In the case of texts such as program metadata, programs are judged more similar when their text expressions include more common index words. Since the text expression of each of the programs P5 and P6 has no index word that is shared by that of any other program, neither of the programs P5 and P6 is judged similar to any other program and each of them is placed into a bin alone. That is, programs that are similar in content can be collected into the same bin by the indexing into an LSH. The set of hashes 1103 is called an LSH (1105). Although for the sake of simplicity FIG. 5 is drawn schematically as if the LSH 51 for indexing of the contents were a single hash, in actuality the LSH 51 is a set of hashes as shown in FIG. 11.

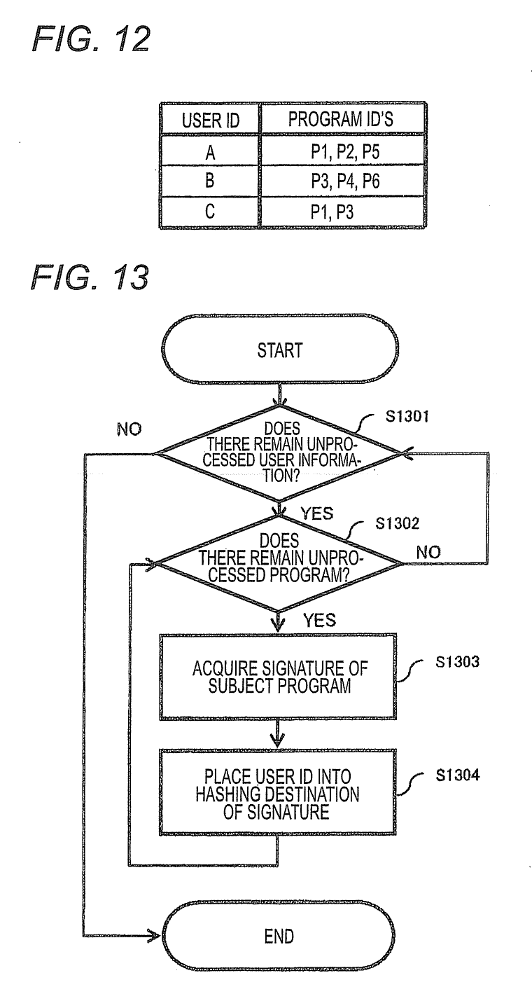

FIG. 12 shows specific examples of user profiles. Each user profile shows what programs the associated user viewed or recorded. For example, the user A viewed the programs P1, P2, and P5 and the user B viewed the programs P3, P4, and P6. It is assumed that the user A is a user who prefers history programs such as programs relating to the World Heritages and the user B is a user who prefers gourmet and tour programs. Such viewing/recording histories can be collected from manipulation histories of the user terminals shown in FIG. 7 such as the TV receiver 74, the hard disk recorder 76, the personal computer 77, and the cell phone 79. Manipulation histories collected from the user terminals are stored in the hard disk drive 713 of the program recommending server 71 via the Web server 73 and accumulated as user profiles as shown in FIG. 12. Manipulation histories may be collected by other methods than the method of using viewing/recording manipulations, such as a method using rating of contents.

FIG. 13 is a detailed flowchart of the user indexing (step S302) in a case that contents are represented by texts such as program metadata.

At step S1301, it is judged whether there remains user information that has not been indexed yet. If it is judged at step S1301 that there remains user information that has not been indexed yet, the process moves to step S1302. On the other hand, if it is judged that all pieces of user information have already been indexed, the process is finished.

At step S1302, it is judged whether there remains, in the user profile, a program that has not been indexed yet. If it is judged at step S1302 that there remains a program that has not been indexed yet, the process moves to step S1303. On the other hand, if it is judged that all programs have already been indexed, the process returns to step S1301. Steps S1301 and S1302 are executed repeatedly until all programs are indexed.

At step S1303, a signature of the subject program is acquired. At step S1304, the user ID corresponding to the subject program is placed into the LSH 1105 shown in FIG. 11. The user ID is placed into the LSH 1105 unlike in FIG. 11.

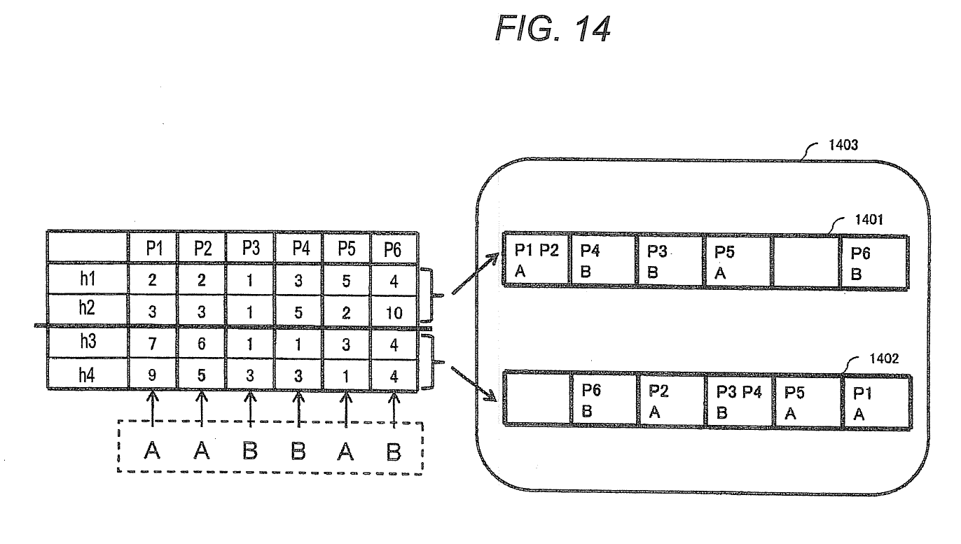

FIG. 14 shows an example of processing of indexing user information into an LSH. A case of indexing the information of the user A will be described below with reference to FIG. 14. Since the user profile of the user A has the programs P1, P2, and P5, these three programs are hashed into an LSH 1403 on a band-by-band basis. The user ID “A” is placed into the hashing destination bins of the programs P1, P2, and P5. Although the information of the user C is not indexed in this example, this is to use the information of the user C in a later description. In actuality, the information of all the users is indexed.

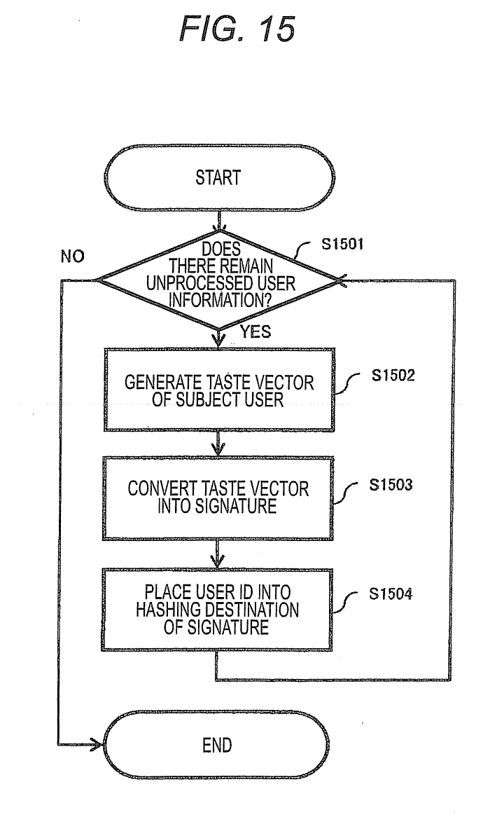

The user indexing method is not limited to the above method of hashing each of the programs viewed by the users, and other various methods can be used. One method is to perform indexing using preference vectorpreference vectors. FIG. 15 is a flowchart of a specific example of a process of expressing, as a preference vectorpreference vector, a set of programs that each user prefers and placing the generated preference vectorpreference vectors into an LSH.

At step S1501, it is judged whether there remains user information that has not been indexed yet. If it is judged at step S1501 that there remains user information that has not been indexed yet, the process moves to step S1502. On the other hand, if it is judged that all pieces of user information have already been indexed, the process is finished.

At step S1502, only one preference vectorpreference vector is generated from a set of feature vectors of programs that the subject user prefers. At step S1503, the preference vectorpreference vector is converted into a signature by the same method as used in the content indexing. At step S1504, the signature is hashed and the user ID is placed into an LSH by the same method as used in the content indexing. Steps S1501 to S1504 are executed repeatedly until all pieces of user information are processed.

In the method using preference vectorpreference vectors, each user ID is placed into only one bin rather than plural bins (the case of FIG. 14). As a result, this method is advantageous in that the user indexing process is increased in speed and hash table referencing can be increased in speed because hash value contention becomes less likely. However, the preference vectorpreference vector generation method strongly depends on the kind of contents and it may be difficult to generate preference vectorpreference vectors in the case where contents are multimedia data.

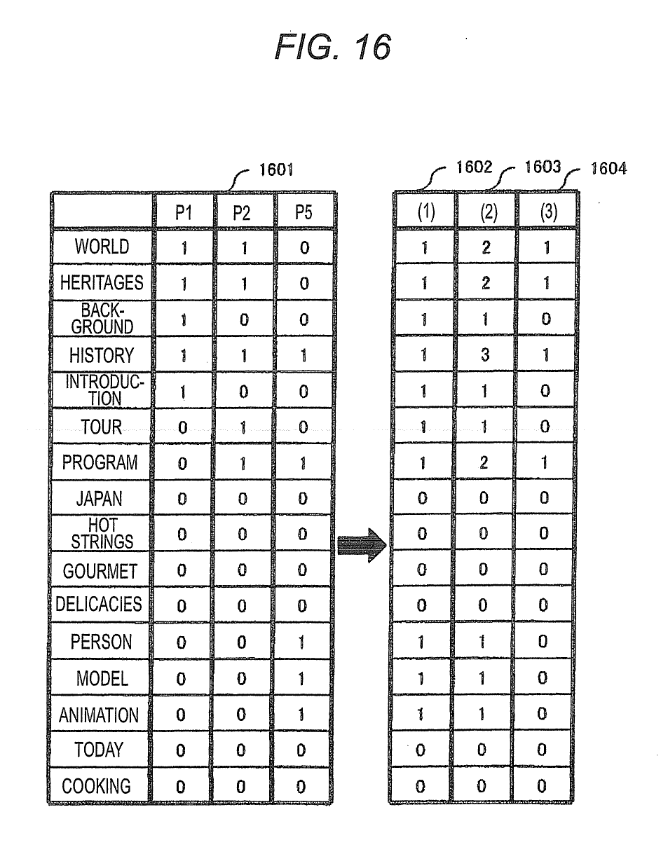

FIG. 16 shows specific examples of the user indexing using preference vectorpreference vectors. A procedure for generating a preference vectorpreference vector of the user A will be described below as an example. A preference vectorpreference vector of the user A will be generated from a set 1601 of feature vectors of programs that the user A viewed. Three specific examples of the method for determining a preference vectorpreference vector from the feature vectors will be described below. A preference vectorpreference vector 1602 is a vector obtained by assigning a value “1” to words included in any of the programs that the user A viewed and a value “0” to words included none of those programs. A preference vectorpreference vector 1603 is a vector obtained by giving each word a count obtained by counting the number of times it appears in the programs that the user A viewed. A preference vector 1604 is a vector obtained by assigning a value “1” to each word whose count used in the preference vector 1603 is larger than or equal to 2 and a value “0” to each word whose count used in the preference vector 1603 is smaller than 2.

Various techniques other than the above ones have been proposed for the method for generating a preference vector, which is called taste modeling. The embodiment can employ only preference vectors like the preference vectors 1602 and 1604 because only a binary vector can be converted into a signature. When preference vectors of the respective users have been generated, they are converted into signatures and user IDs are placed into an LSH in the same manners as programs are done.

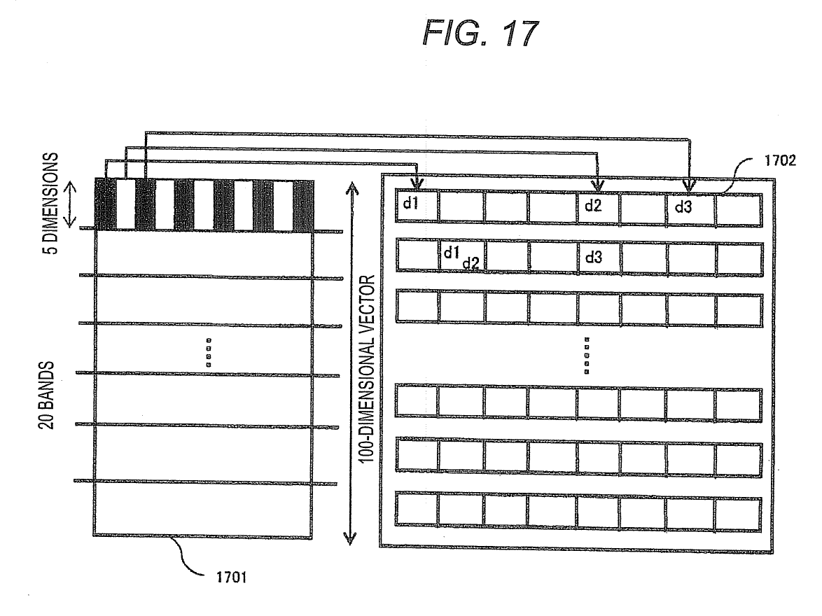

FIG. 17 is a schematic chart showing how a large-scale set of contents or pieces of user information is indexed. As mentioned above, large-scale systems have signatures of many dimensions; a signature matrix 1701 has signatures of 100 dimensions. Therefore, if the band width is set at 5 dimensions, 20 bands are formed and the number of corresponding hashes is as large as 20. The probability that contents are judged similar can be adjusted by adjusting the band width.

The processes for indexing contents and pieces of user information have been described above for the case that the contents are programs.

A program recommending process will be described below with reference to the flowchart of FIG. 4. This process is independent of the kind of contents and hence is the same as described above. A description will be made of an example that programs are recommended to the user C shown in FIG. 12. In this case, at step S401, the fact that the user C prefers the two programs, that is, the program P11 (“World Heritages and their histories”) and the program P2 (“Tour of hot springs”), is input to the program recommending server 71 via the user profile input section 271.

The content recommending section 27 searches the LSH 1403 (see FIG. 14) for similar programs at step S402 and searches the LSH 1403 for similar users at step S403. The programs P1 and P3 are hashed into all the hashes constituting the LSH 1403 and each set of programs and a user ID that are placed in the same hashing destination bin is extracted.

In this example, the programs P1, P2, P3, and P4 are obtained as similar programs. The programs P1 and P3 that the user C already knows are excluded and the programs P2 and P4 are recommended as programs that are similar to the programs that the user C prefers. This is content-based recommendation.

The users A and B are obtained as users who are similar in tastes to the user C. The user profile DB 24 is searched for user profiles of the users A and B, whereby the programs P1, P2, and P5 and the programs P3, P4, and P6 are obtained. The programs P1 and P3 that the user C already knows are excluded and the programs P2, P5, P4, and P6 are recommended (step S404). This is collaborative filtering type recommendation because the user profiles of the users who are similar in tastes to the user C are used. The collaborative filtering type recommendation can recommend, as related programs that other users were interested in, even programs that are judged not similar by the content-based judgment like the program P5 (“Historical animations”) and the program P6 (“Today's Cooking”).

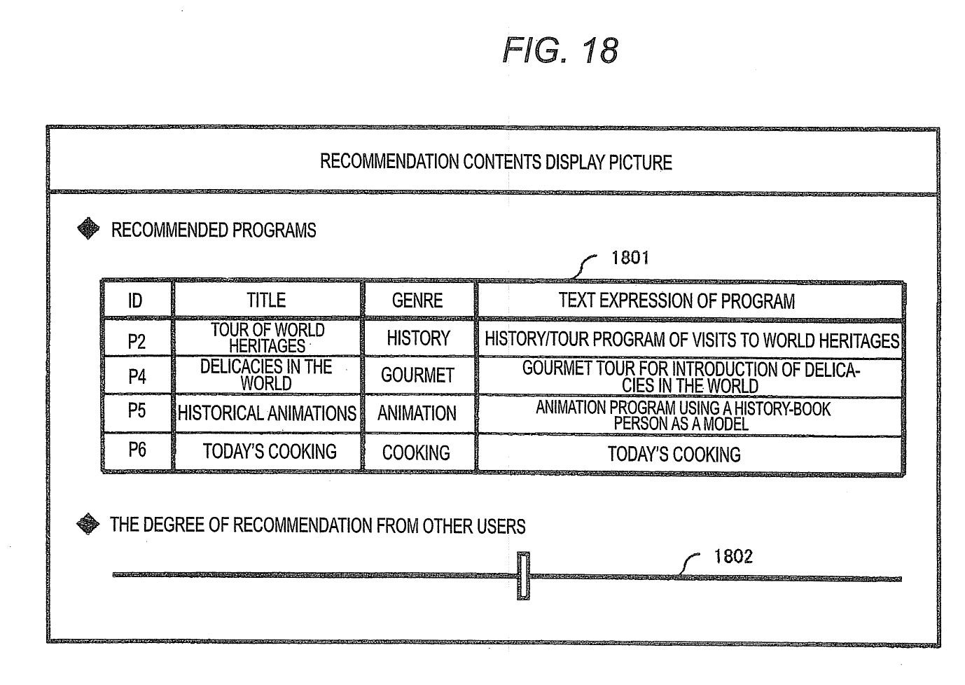

Finally, at step S405, the recommendation programs of the content-based recommendation and those of the collaborative filtering type recommendation are combined together. Several combining methods are available. For example, the programs P2, P4, P5, and P6 are recommended if the two sets of recommendation programs are ORed. The programs P2 and P4 are recommended if the two sets of recommendation programs are ANDed. FIG. 18 shows a specific example of a recommendation list that is presented to the user C. As shown in FIG. 18, a scroll bar 1802 called “the degree of recommendation from other users” may be provided to allow the user C to determine at what proportions a list should include recommendation programs of the content-based recommendation and those of the collaborative filtering type recommendation. It is known that in general many programs that cannot be expected by a recommendation request user tend to be recommended if the proportion of recommendation programs of the collaborative filtering type recommendation is set high. Another method (mentioned above) may be employed in which great importance is attached to the content-based recommendation at a start of a recommendation operation and the collaborative filtering type recommendation is regarded as more important as the number of users increases. A recommendation list produced by the combining is transmitted to the user terminal such as the TV receiver 74 from the program recommendation server 71 and presented to the user C in the form of the recommendation program list 1801 of FIG. 18.

The invention is not limited to the above embodiment itself and, in the practice stage, may be embodied in such a manner that the constituent elements are modified without departing from the spirit and scope of the invention. And various inventions can be conceived by properly combining plural constituent elements disclosed in the embodiment. For example, several ones of the constituent elements of the embodiment may be omitted.

In the above embodiment, the processes were described for the case that contents are represented by text data as in TV programs. As long as contents are data that are represented by text data as in book data, websites, news articles, or blogs, a similar recommending system can be constructed by employing the above processes. In the case of contents represented by feature vectors such as music, images, or moving images, the contents can be indexed into an LSH by the method described in M. S. Charikar, “Similarity Estimation Techniques from Rounding Algorithms,” Proceedings of the 34th Annual ACM Symposium on Theory of Computing, 2002, and M. Datar, N. Immorlica, P. Indyk, and V. S. Mirrokni, “Locality-Sensitive Hashing Scheme on p-Stable Distributions,” Proceedings of the 20th Annual Symposium on Computational Geometry, 2004. A similar recommending system can be constructed by using the indexing and the recommending method according to the invention.

As described with reference to the above embodiment, there is provided a hybrid content recommending server, system, and method which have the advantages of both of the content-based recommending system and the collaborative filtering recommending system and can recommend contents at high speed even if the number of users and the number of contents are large.

The above embodiment provides a hybrid content recommending server, system, and method which have the advantages of both of the content-based recommending system and the collaborative filtering recommending system and can recommend contents at high speed even if the number of users and the number of contents are large.

What is claimed is:

1. A content recommending server comprising:
a content information collecting section collecting content information including metadata of contents from a content server through a network;
a content database storing the content information collected by the content information collecting section;
a user profile collecting section collecting user profiles of users from user terminals through the network, each of the user profiles including each user's preference with respect to the contents;
a user profile database storing the user profiles collected by the user profile collecting section, the user profiles including a subject user profile of a subject user;
a content indexer acquiring the metadata from the content database and generating content indices of the contents from the metadata;
a user indexer acquiring the user profiles from the user profile database and generating user indices of each of the users by using the preference as a key;
an index database storing the content indices and the user indices; and
a content recommending section receiving the subject user profile from the user profile database, searching the index database for an certain index corresponding to the subject user profile, and determining a recommend content suitable for a preference of the subject user based on the certain index.

2. The server according to claim 1, wherein the content indexer acquires the metadata from the content database and generates the content indices of the contents from the metadata based on locality-sensitive hashing (LSH),
wherein the user indexer acquires the user profiles from the user profile database and generates the user indices of each of the users by using the preferences as a key based on the LSH.

3. The server according to claim 1, wherein the content recommending section includes:
a user profile input section to which the subject user profile is inputted;
a similar user search section searching for a similar user profile that is similar in a preference with respect to the contents to the subject user profile by referring to the user indices based on the subject user profile;
a similar content search section searching for similar contents that are similar to contents that the subject user prefers by referring to the contents indices based on the subject user profile;
a recommendation content determining section determining at least one of recommendation contents by applying collaborative filtering to the similar user profile and
a recommendation contents list generating section generating a recommendation contents list by combining a list of the similar contents and a list of the recommendation contents according to a certain rule.

4. The server according to claim 1, wherein the content indexer generates feature vectors by selecting index words from morphemes obtained by performing a morphological analysis on the content information and divides signatures obtained by reducing dimensions of the feature vectors into bands having a certain band width to generate the contents indices on each of the bands.

5. The server according to claim 1, wherein the user indexer generates preference vectors representing sets of contents that the users prefer based on the meta data and the user profiles and divides signatures that are obtained by reducing dimensions of the preference vectors into bands having a certain band width to generate the user indices on each of the band.

6. The server according to claim 3, wherein the recommendation contents list generating section combines the list of the similar contents and the list of the recommendation contents by a ratio specified by a subject user terminal.

7. A content recommending system comprising:
a content server providing metadata of contents;
a content recommending server managing metadata of the contents and user profiles and outputting a content recommendation list, the content recommending server being connected to the content server through a network; and
a plurality of user terminals each connected to the content recommending server through the network,
wherein the content recommending server includes:
a content information collecting section collecting content information including the metadata of the contents from the content server through the network;
a content database storing the content information collected by the content information collecting section;
a user profile collecting section collecting user profiles of users from user terminals through the network, each of the user profiles including each user's preference with respect to the contents;
a user profile database storing the user profiles collected by the user profile collecting section, the user profiles including a subject user profile of a subject user;
a content indexer acquiring the metadata from the content database and generating content indices of the contents from the metadata;
a user indexer acquiring the user profiles from the user profile database and generating user indices of each of the users by using the preference as a key;
an index database storing the content indices and the user indices; and
a content recommending section receiving the subject user profile from the user profile database, searching the index database for an certain index corresponding to the subject user profile, and determining a recommend content suitable for a preference of the subject user based on the certain index.

8. The system according to claim 7, wherein the content indexer acquires the metadata from the content database and generates the content indices of the contents from the metadata based on locality-sensitive hashing (LSH), and
wherein the user indexer acquires the user profiles from the user profile database and generates the user indices of each of the users by using the preferences as a key based on the LSH.

9. A content recommending method comprising:
collecting content information including metadata of contents from a content server through a network;
collecting user profiles of users from user terminals through the network, each of the user profiles including each user's preference with respect to the contents;
generating content indices of the contents from the metadata;
generating user indices of each of the users by using the preference as a key;
acquiring a subjected user profile of a subject user from the collected user profiles;
searching content indices and user indices for an certain index corresponding to the subject user profile, and
determining a recommend content suitable for a preference of the subject user based on the certain index.

10. The hybrid content recommending method according to claim 9, wherein, in the content indices generating step, the content indices are generated from the metadata based on locality-sensitive hashing (LSH), and
wherein, in the user indices generating step, the user indices are generated by using the preferences as a key based on the LSH.
